(19) United States
(12) Patent Application Publication
(10) Pub. No.: US 2010/0085848 A1
(43) Pub. Date: Apr. 8, 2010

(54) METHOD FOR PERFORMING TRACK-SEEKING IN AN OPTICAL DISK DRIVE

(75) Inventors: Po-Ching LU, Taichung City (TW); Chun-Ying CHIANG, Chiayi City (TW); Shr-Cheng LI, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/246,724

(22) Filed: Oct. 7, 2008

(51) Int. Cl. G11B 7/00

(52) U.S. Cl. 369/44.28; G9B/7

(57) ABSTRACT

The invention provides a method for performing track-seeking in an optical disk drive. In one embodiment, the optical disk drive is about to perform a series of operations comprising a plurality of prior operations and a track-seeking operation, and the track-seeking operation is divided into a pre-seek procedure and a true-seek procedure. First, a microprocessor of the optical disk drive performs the prior operations. Whether the microprocessor is unoccupied is then detected before performing the prior operations is completed. When the microprocessor is detected to be unoccupied, the microprocessor performs the pre-seek procedure. The true-seek procedure is then performed according to results of the pre-seek procedure to move the pick-up head to a destination address of an optical disk.

### BACKGROUND OF THE INVENTION

1. Field of the Invention

The invention relates to optical disk drives, and more particularly to track-seeking processes of optical disk drives.

2. Description of the Related Art

Track-seeking is a procedure frequently performed by an optical disk drive. An optical disk drive performs a track-seeking procedure to move a pick-up head of the optical disk drive to a destination address. Thus, data recorded on the destination address can be read and transferred to a host, or data transferred from a host can be recorded on the destination address when the optical disk drive respectively performs a reading or writing operation.

Because both a reading operation and a writing operation comprise track-seeking procedures, an optical disk drive therefore frequently performs track-seeking procedures. If time required by track-seeking procedures is reduced, time required by a reading operation and a writing operation is thus further reduced, and performance of the optical disk drive is therefore greatly improved. A conventional method for reducing time required by track-seeking procedures is to fine-tune servo parameters of a sled actuator and a coil actuator used in the track-seeking procedures. The conventional method, however, only minimally reduces required time and does not distinctly improve system performance. Thus, a novel method for performing track-seeking in an optical disk drive is required.

### BRIEF SUMMARY OF THE INVENTION

The invention provides a method for performing track-seeking in an optical disk drive. In one embodiment, the optical disk drive performs a series of operations comprising a plurality of prior operations and a track-seeking operation, and the track-seeking operation is divided into a pre-seek procedure and a true-seek procedure. First, a microprocessor of the optical disk drive performs the prior operations. Whether the microprocessor is unoccupied is then detected before performing the prior operations is completed. The microprocessor then performs the pre-seek procedure when the microprocessor is detected to be unoccupied. The true-seek procedure is then performed according to results of the pre-seek procedure to move the pick-up head to a destination address of an optical disk.

The invention also provides an optical disk drive. In one embodiment, the optical disk drive comprises a coil actuator, a sled actuator, and a microprocessor. The coil actuator generates a first driving signal to control a coil. The sled actuator generates a second driving signal to control a sled. The microprocessor performs a series of prior operations, detects whether the microprocessor is unoccupied before performing the prior operations is completed, performs a pre-seek procedure of a track-seeking operation when the microprocessor is unoccupied, and controls the coil actuator and the sled actuator to perform a true-seek procedure of the track-seeking operation according to results of the pre-seek procedure to move the pick-up head to a destination address of an optical disk, wherein the pre-seek procedure performs preparatory tasks for the true-seek procedure.

The invention also provides a method for processing commands in an optical disk drive. In one embodiment, processing of each command comprises a track-seeking operation and a plurality of other operations, and the track-seeking operation is divided into a pre-seek procedure and a true-seek procedure. First, a microprocessor of the optical disk drive performs the pre-seek procedure of a current command. The microprocessor then performs the other operations of the current command. Whether the microprocessor is unoccupied is then detected during performing the other operations of the current command. When the microprocessor is detected to be unoccupied, the microprocessor performs the pre-seek procedure of a next command. The true-seek procedure of the next command is then directly performed according to results of the pre-seek procedure of the next command to move the pick-up head from an initial address to a destination address of an optical disk. Finally, the next command is taken as the current command to repeat the aforementioned steps except the first step until all of the commands are processed.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a block diagram of an optical disk drive performing a reading operation;

FIG. 2 shows a block diagram of an optical disk drive performing a writing operation;

FIG. 3 shows a flowchart of a method for performing a track-seeking operation;

FIG. 4A shows a schematic diagram of conventional processing of reading commands;

FIG. 4B shows a schematic diagram of processing of reading commands according to the invention;

FIG. 5 shows a flowchart of a method for processing commands in an optical disk drive according to the invention;

FIG. 6 shows a flowchart of a method for reading an optical disk with defect management operation according to the invention; and

FIG. 7 shows a flowchart of a method for recording data on an optical disk with defect management according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

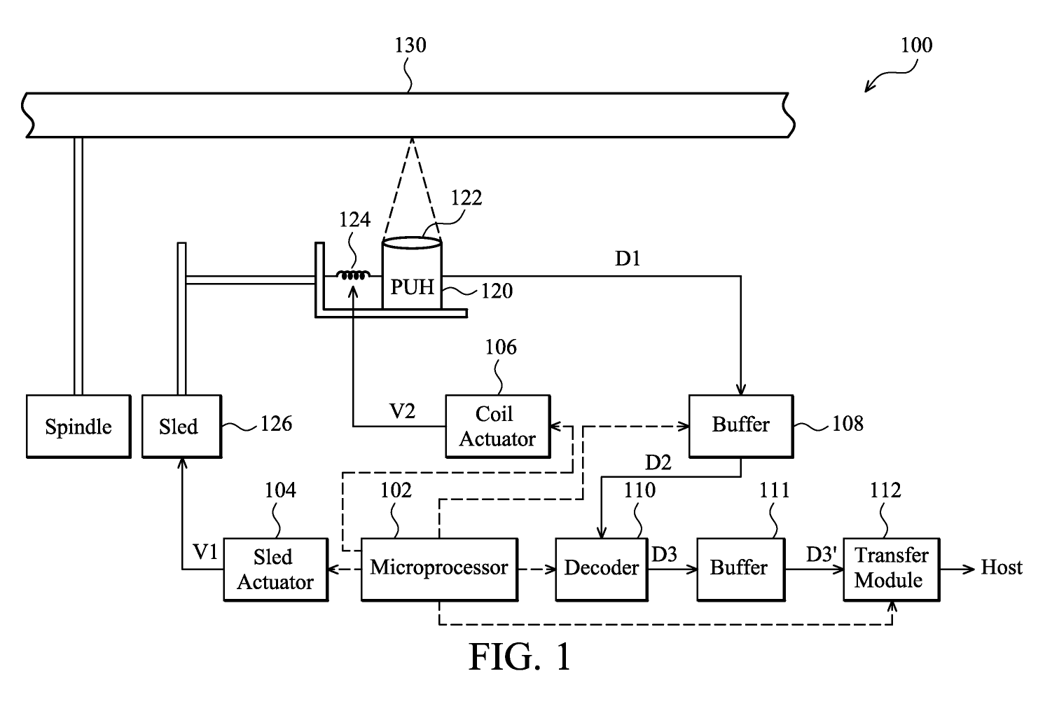

Referring to FIG. 1, a block diagram of an optical disk drive 100 performing a reading operation is shown. The optical disk drive 100 comprises a microprocessor 102, a sled actuator 104, a coil actuator 106, buffers 108 and 111, a decoder 110, a transfer module 112, a pick-up head 120, a lens 122, a coil 124, and a sled motor 126. When the optical disk drive 100 reads data from an optical disk 130, the procedures including a track-seeking procedure, a buffering procedure, a decoding procedure, and a transferring procedure are performed. The microprocessor 102 first triggers the sled actuator 104 and the coil actuator 106 to generate driving signals V₁ and V₂. The sled motor 126 moves the pick-up head 120 according to the driving signal V₁ to a vicinity of a destination address. The coil 124 then finely adjusts location of the pick-up head 120 according to the driving signal V₂ to put the pick-up head 120 on the destination address, and the track-seeking procedure is completed.

The pick-up head 120 then reads raw data from the optical disk. The microprocessor 102 then controls the buffer 108 to store the raw data D₁, and the buffering procedure is completed. The microprocessor 102 then controls the decoder 110 to decode buffering data D₂ to obtain decoded data D₃, and the decoding procedure is completed. The decoded data D3 is then stored in the buffer 111. The microprocessor 102 then controls a transfer module 112 to retrieve the decoded data D₃′ from the buffer 111 and transfer the decoded data D₃′ to a host, and a transferring procedure is completed. Thus, data is read from the optical disk 130 and transferred to a host.

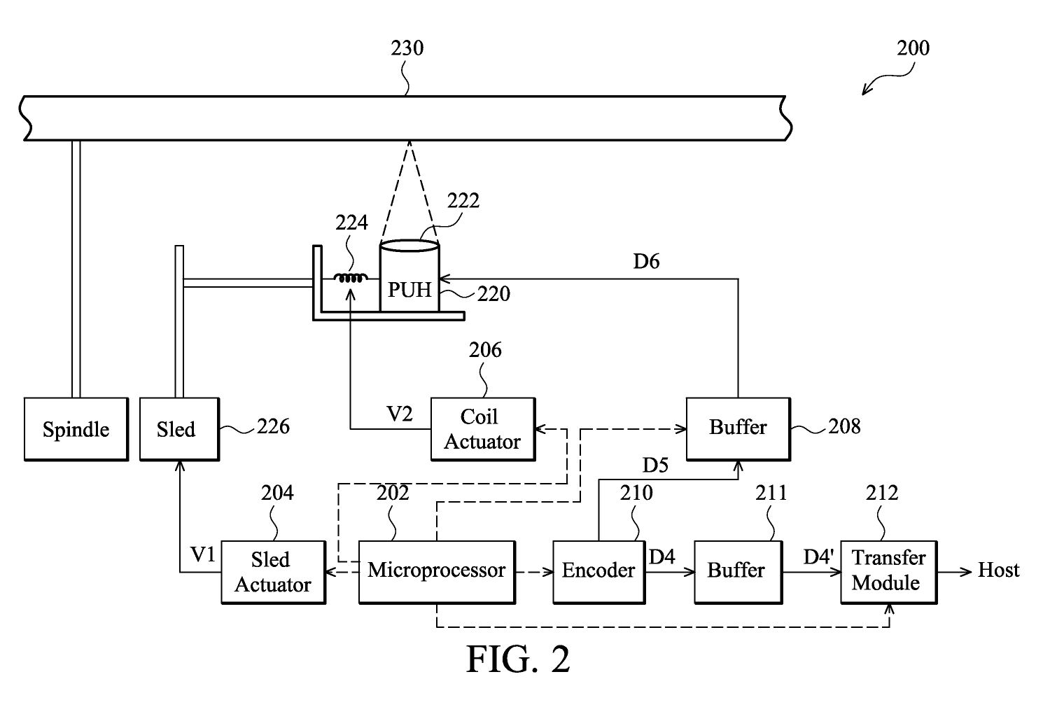

Referring to FIG. 2, a block diagram of an optical disk drive 200 performing a writing operation is shown. Similarly, the procedures including a buffering procedure, a track-seeking procedure, an encoding procedure, and a recording procedure, are performed to write data to the optical disk 230. A microprocessor 202 of the optical disk drive 200 controls a transfer module 212 to receive data D₄′ from a host and store the data D₄′ in a buffer 211, and a buffering procedure is completed. The microprocessor 202 then controls a sled actuator 204 and a coil actuator 206 to move a pick-up head 220 to a destination address, and a track-seeking procedure is completed. The microprocessor 202 then controls an encoder 210 to retrieve data D₄ from the buffer 211 and generate encoded data D₅ according to data D₄, and the encoding procedure is thus completed, and the encoded data D₅ is stored in a buffer 208. The microprocessor 202 then controls the pick-up head 220 to record buffering data D₆ retrieved from the buffer 208 on the optical disk 230, and the recording procedure is completed. Thus, data is transferred from a host and recorded on the optical disk 230.

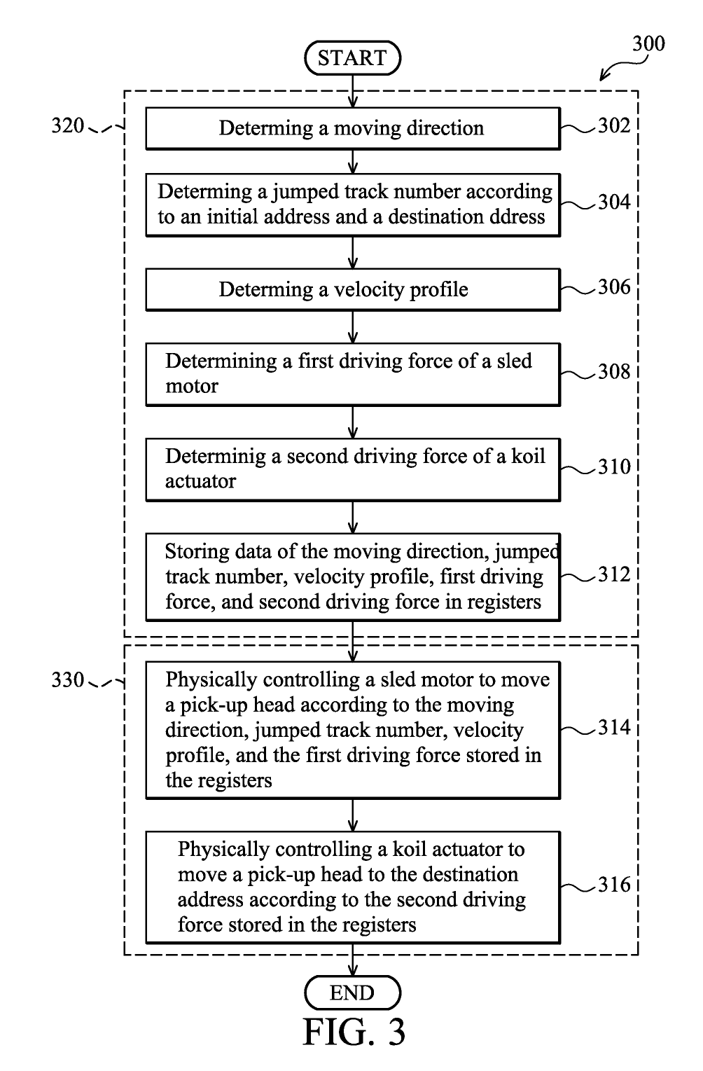

A track-seeking operation moves a pick-up head of an optical disk drive to a destination address on an optical disk. The track-seeking operation comprises several steps. Referring to FIG. 3, a flowchart of a method 300 for performing a track-seeking operation is shown. (Please refer to FIG. 1 simultaneously.) Before a sled actuator 104 and a coil actuator 106 generates driving signals V₁ and V₂ to move the pick-up head 120, a microprocessor 102 must perform a lot of preparatory tasks. First, the microprocessor 102 determines a moving direction of the pick-up head in step 302. The microprocessor 102 then determines a jumped track number according to an initial address and a destination address in step 304. A velocity profile is then determined in step 306. In addition, the microprocessor 102 also determines a first driving force of a sled motor 126 in step 308 and a second driving force of the coil 124 in step 310. The microprocessor 102 then stores data of the moving direction, the jumped track number, the velocity profile, the first driving force, and the second driving force in registers in step 312. In one embodiment, the velocity profile comprises a plurality of parameter values for controlling moving velocities of the sled 126 and the coil 124 during a track-seeking operation.

The microprocessor 102 then controls the sled actuator 104 to generate the driving signal V₁ according to the data of moving direction, jumped track number, velocity profile, and the first driving force stored in the registers in step 314, and then the sled motor 126 is physically controlled by the driving signal V₁ to move the pick-up head 120. The microprocessor 102 also controls the coil actuator 106 to generate the second driving force according to the data of driving signal V₂ stored in the registers in step 316, and then the coil 124 is physically controlled by the driving signal V₂ to move the pick-up head 120 to the destination address. Thus, the track-seeking operation is completed.

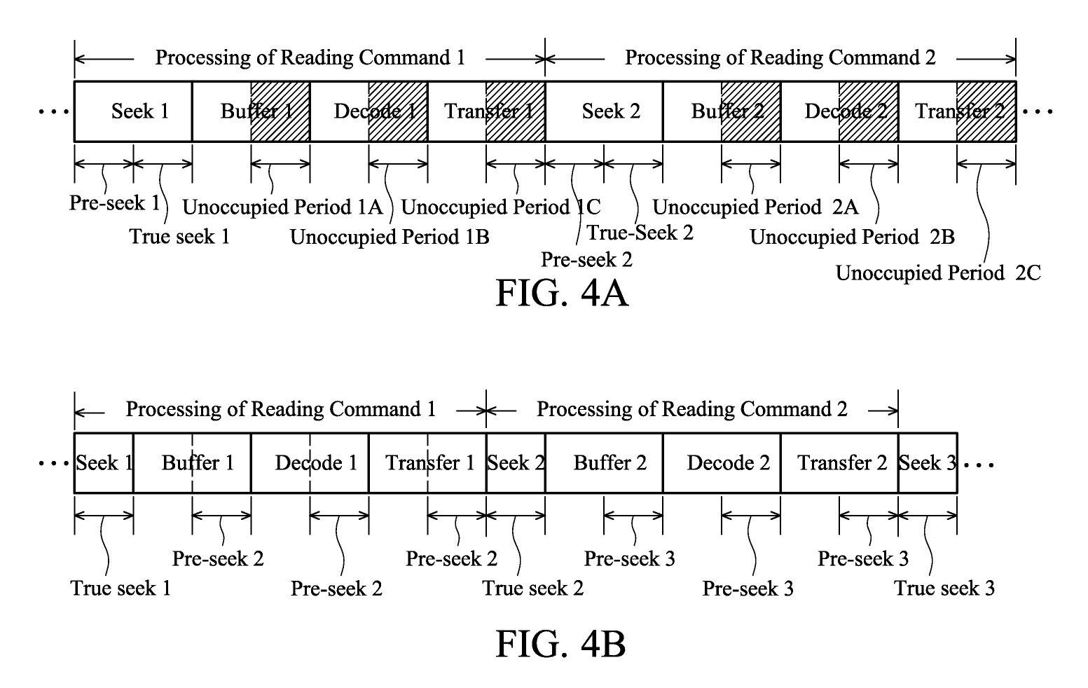

The steps 314 and 316 are steps which physically move the pick-up head. The steps 302 to 312 can be taken as preparatory tasks. Thus, the steps of a track-seeking operation can be divided into two portions: a pre-seek procedure 320 comprising steps 302 to 312 and a true-seek procedure 330 comprising steps 314 and 316. The true-seek procedure 330 physically moves the pick-up head to the destination address, and the pre-seek procedure 320 performs preparatory tasks for the true-seek procedure 330. When an optical disk drive performs a series of operations comprising a plurality of prior operations and a track-seeking operation, a microprocessor of the optical disk drive is often unoccupied before the prior operations are completed. In other words, before the prior operations are completed, the microprocessor may be unoccupied without operating the prior operations, and the microprocessor is referred as to be in an “unoccupied state”. In one embodiment, the microprocessor is in an unoccupied state when the microprocessor does not operate a true-seek procedure, which will be further illustrated with FIGS. 4A and 4B

It is noted that the number of the steps and the arrow symbols in FIG. 3 are used to explain the track-seeking operation conveniently, rather than used to indicate the sequential relationship. For example, determining the first driving force of the sled motor 126 of step 308 is not necessary performed after determining the velocity profile of step 306.

Moreover, the prior operations may be any operations performed by the optical disk drive before the track-seeking operation is performed and are further illustrated with FIGS. 4A and 4B. In one embodiment, the prior operation is another track-seeking operation executed in advance of the track-seeking operation. For example, the buffer 1 procedure, the decode 1 procedure, and the transfer 1 procedure for performing a read command 1 in FIGS. 4A and 4B are prior operations of the track seeking operation for performing a read command 2. The microprocessor therefore can perform a portion of a pre-seek procedure of the track-seeking operation during unoccupied periods in which the microprocessor is spare or unoccupied by processing of the read command 1. Thus, when the track-seeking operation is triggered, only the true-seek procedure is performed, and time required by the track-seeking operation is reduced to improve performance of the optical disk drive.

For example, an optical disk processes a reading command by sequentially performing a track-seeking procedure, a buffering procedure, a decoding procedure, and a transferring procedure, as shown in FIG. 1. If a track-seeking procedure is divided into a pre-seek procedure and a true-seek procedure, and a pre-seek procedure of a next reading command is preformed during unoccupied periods of a microprocessor when the buffering procedure, the decoding procedure, and the transferring procedure of a current reading command is being performed, the time required by the track-seeking procedure of the next reading command is reduced to the time required by the true-seek procedure. Thus, when an optical disk drive must process a lot of reading commands sent by a host, processing time of the reading commands are greatly reduced, and performance of the optical disk drive is improved.

Referring to FIG. 4A, a schematic diagram of conventional processing of reading commands is shown. A microprocessor 102 processes a reading command by performing a track-seeking procedure, a buffering procedure, a decoding procedure, and a transferring procedure. The track-seeking procedure comprises a pre-seek procedure and a true-seek procedure. For example, the ‘seek 1’ procedure comprises a pre-seek 1 procedure and a true-seek 1 procedure. Because the buffering procedure, the decoding procedure, and the transferring procedure are physically performed by the buffer 108, the decoder 110, and the transfer module 112, respectively, the microprocessor is sometimes unoccupied while the buffering procedure, the decoding procedure, and the transferring procedure are being performed, such as the unoccupied periods 1A, 1B, 1C, 2A, 2B, and 2C.

Referring to FIG. 4B, a schematic diagram of processing of reading commands according to the invention is shown. The pre-seek procedure of the reading command 2 (Pre-seek 2) is performed during unoccupied periods of buffering procedure, decoding procedure, and transferring procedure of reading command 1, and the pre-seek procedure of the reading command 3 (Pre-seek 3) is performed during unoccupied periods of buffering procedure, decoding procedure, and transferring procedure of reading command 2. Thus, the time required by a track-seeking procedure is reduced. From FIGS. 4A and 4B, the time reduced can be the whole duration operating the pre-seek 2 procedure.

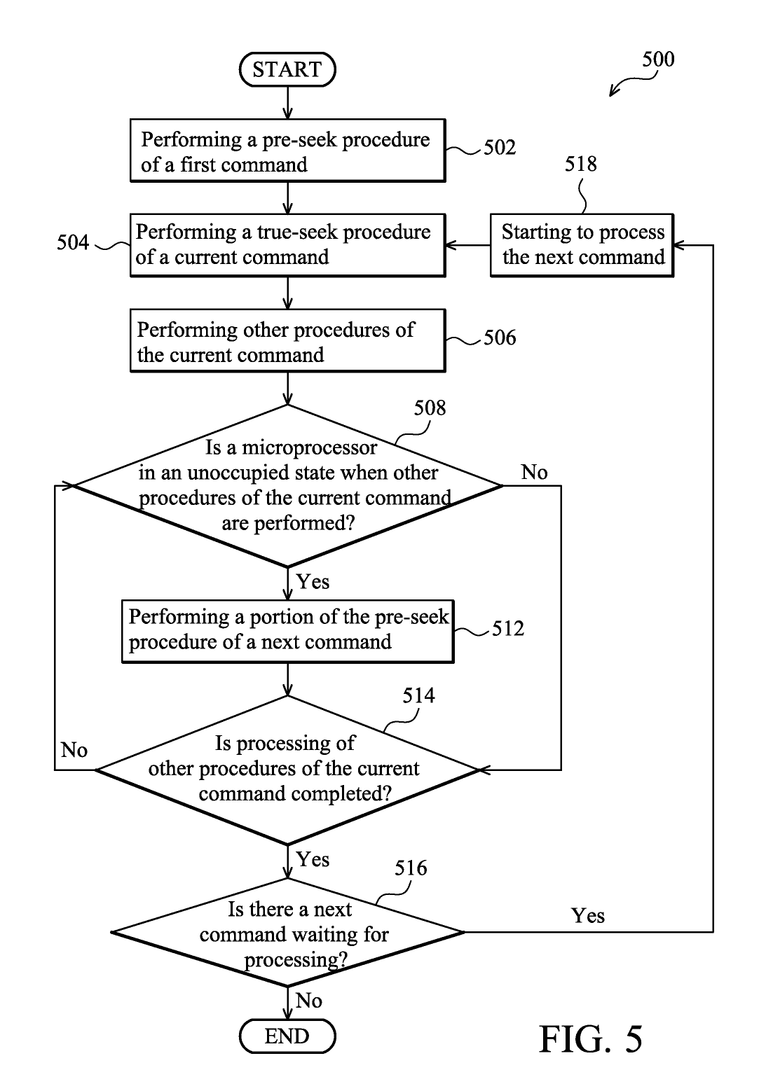

Referring to FIG. 5, a flowchart of a method 500 for processing commands in an optical disk drive according to the invention is shown. The optical disk drive is processing a series of commands sent by a host, and processing of each command requires a track-seeking operation and other operations. For example, the series of commands may be Native Command Queuing (NCQ) reading commands, and the other operations include a buffering procedure, a decoding procedure, and a transferring procedure. The series of commands may also be writing commands, and the other operations include a buffering operation, an encoding operation, and a recording operation.

A microprocessor of the optical disk drive first performs a pre-seek procedure and a true-seek procedure of a first command, which is a current command, in steps 502 and 504. The microprocessor then performs the other procedures of the current command in step 506. When the other procedures of the current command are performed, whether the microprocessor is in an unoccupied state is detected in step 508. If the microcontroller is in the unoccupied state, the pre-seek procedure of a next command is then performed during unoccupied periods of the microprocessor in step 512 before processing of other procedures of the current command is completed in step 514. To process the next command, the true-seek procedure of the next command is then directly performed in step 504. Thus, the time required by each command processing is reduced because the pre-seek procedure is performed during unoccupied periods of a previous command processing.

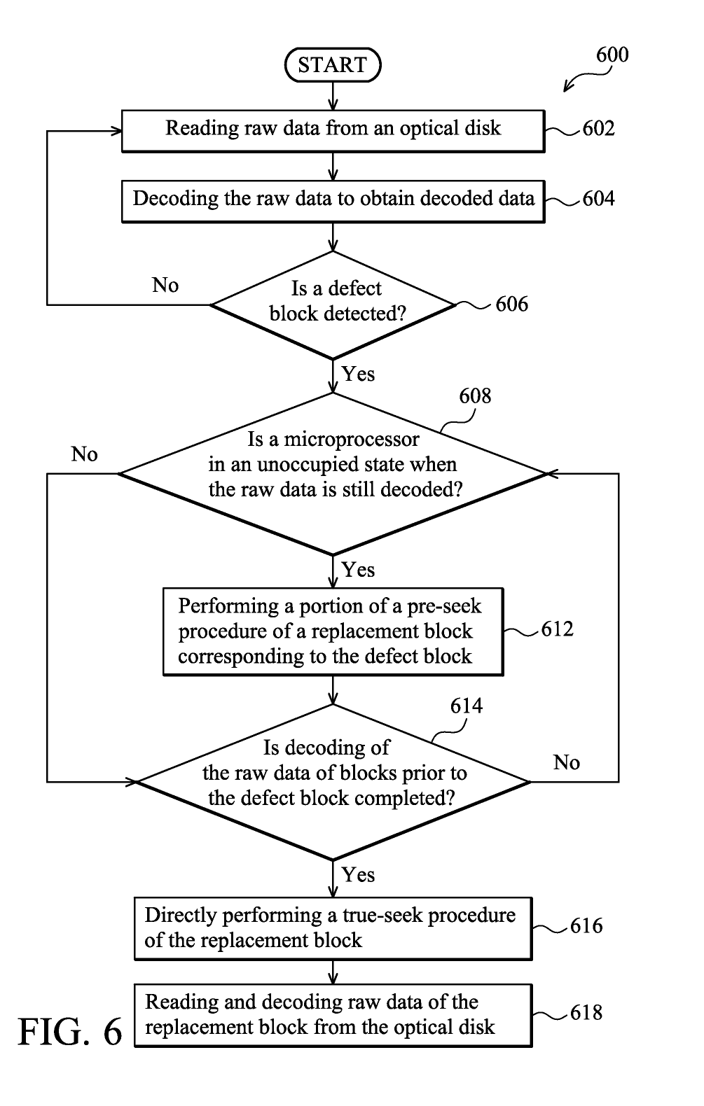

An optical disk with defect management stores data of a defect block in a corresponding replacement block in spare area of the optical disk. Thus, the pick-up head of the optical disk drive must be moved to the address of the replacement block to read data when a defect block occurs. The parallel processing of track-seeking procedure introduced by the invention can also be applied to move a pick-up head to the replacement block corresponding to the defect block. Referring to FIG. 6, a flowchart of a method 600 for reading an optical disk with defect management operation according to the invention is shown. The defect management operation is one kind of the prior operations described above. First, raw data is read from an optical disk drive in step 602. The raw data is then decoded to obtain decoded data in step 604. While the pick-up head reads raw data from the optical disk, a defect block may occurs in step 606 and be found by the pick-up head, but the raw data of blocks prior to the defect block is still being decoded. Whether a microprocessor of the optical disk drive is in an unoccupied state is then detected in step 608. If so, the pre-seek procedure in preparation for physically moving the pick-up head to a destination address of a replacement block corresponding to the defect block is then performed during unoccupied periods of the microprocessor in step 612 before the raw data of blocks prior to the defect block is completely decoded in step 614. Thus, a true-seek procedure 616 physically moving the pick-up head to the replacement block can be directly performed according to register settings of the pre-seek procedure in step 616, and raw data of the replacement block can be read from the optical disk and decoded in step 618.

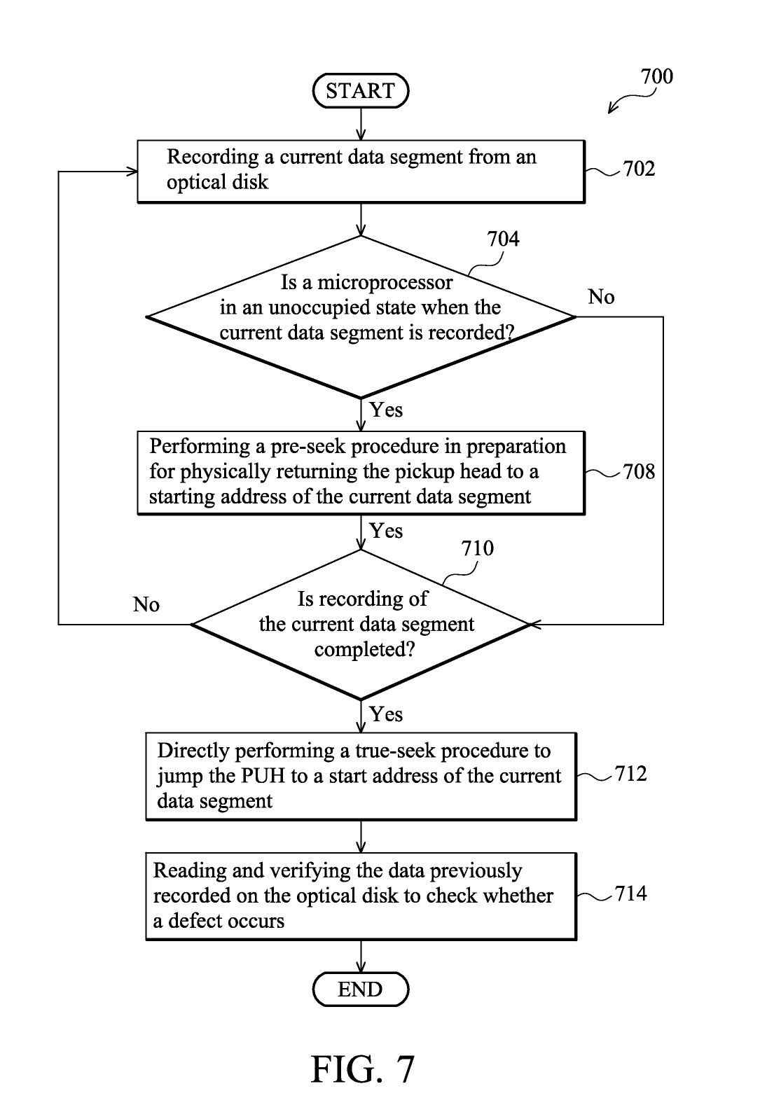

The parallel processing of track-seeking procedure introduced by the invention can also be applied to writing data to an optical disk with defect management. After an optical disk drive records a segment of data on the optical disk, a pick-up head of the optical disk drive is moved back to the starting address of the data segment to verify the accuracy of the recorded data segment. Thus, occurrence of a defect block can be detected if the recorded data read out by the pick-up head has errors. Referring to FIG. 7, a flowchart of a method 700 for recording data on an optical disk with defect management according to the invention is shown. First, a current data segment is recorded on an optical disk in step 702. When the current data segment is recorded, whether a microprocessor of the optical disk drive is in an unoccupied state is detected in step 704. A pre-seek procedure in preparation for physically returning the pick-up head to the starting address of the current data segment is performed during unoccupied periods of the microprocessor in step 708 before recording of the current data segment is completed in step 710. Thus, a true-seek procedure physically moving the pick-up head to the starting address of the recorded data segment can be directly performed in step 712. Previously recorded data can then be read from the data segment and verified to check whether a defect block has occurred in step 714.

The method provides a method for performing track-seeking in an optical disk drive. A track-seeking operation is divided into a true-seek procedure physically moving a pick-up head of the optical disk drive and a pre-seek procedure performing preparatory tasks for the true-seek procedure. The pre-seek procedure can be performed during unoccupied periods of a microprocessor of the optical disk drive, and the time required by the track-seeking operation is reduced to the time required by the true-seek procedure. Thus, performance of the optical disk drive is improved.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for performing track-seeking in an optical disk drive, wherein the optical disk drive performs a series of operations comprising a plurality of prior operations and a track-seeking operation, and the track-seeking operation is divided into a pre-seek procedure and a true-seek procedure, the method comprising:
performing the prior operations with a microprocessor of the optical disk drive;
detecting whether the microprocessor is unoccupied before performing the prior operations is completed;
performing the pre-seek procedure with the microprocessor when the microprocessor is detected to be unoccupied, wherein the pre-seek procedure performs preparatory tasks for the true-seek procedure; and
performing the true-seek procedure according to results of the pre-seek procedure to move the pick-up head to a destination address of an optical disk.

2. The method as claimed in claim 1, wherein the pre-seek procedure comprises:
determining a moving direction of the pick-up head;
determining a jumped track number according to the initial address and the destination address;
determining a velocity profile;
determining a first driving force of a sled actuator of the optical disk drive;
determining a second driving force of a coil actuator of the optical disk drive; and
storing the results of the pre-seek procedure comprising the moving direction, the jumped track number, the velocity profile, the first driving force, and the second driving force in registers.

3. The method as claimed in claim 1, wherein the true-seek procedure comprises:
controlling the sled actuator to move the pick-up head according to the results of the pre-seek procedure; and
controlling the coil actuator to move the pick-up head to the destination address according to the results of the pre-seek procedure.

4. The method as claimed in claim 1, wherein the prior operations are about processing read commands.

5. The method as claimed in claim 4, wherein one of the prior operations is a buffering operation for buffering raw data read by a pickup head.

6. The method as claimed in claim 4, wherein one of the prior operations is a decoding operation for decoding the raw data to obtain a data segment.

7. The method as claimed in claim 4, wherein one of the prior operations is a transferring operation for transferring the data segment to a host.

8. The method as claimed in claim 1, wherein the prior operations are about processing write commands.

9. The method as claimed in claim 8, wherein one of the prior operations is a buffering operation buffering a data segment sent by a host.

10. The method as claimed in claim 8, wherein one of the prior operations is an encoding operation encoding the data segment to obtain encoded data.

11. The method as claimed in claim 8, wherein one of the prior operations is a recording operation recording the encoded data on the optical disk.

12. The method as claimed in claim 1, wherein the series of operations are performed for defect management.

13. The method as claimed in claim 12, wherein the pre-seek procedure is arranged to performs preparatory tasks for preparing to seek a replacement block.

14. The method as claimed in claim 12, wherein the pre-seek procedure is arranged to performs preparatory tasks for preparing to seek a starting address of the data segment recorded on the optical disk.

15. An optical disk drive, comprising:
a coil actuator, generating a first driving signal to control a coil;
a sled actuator, generating a second driving signal to control a sled;
a microprocessor, performing a series of prior operations, detecting whether the microprocessor is unoccupied before performing the prior operations is completed, performing a pre-seek procedure of a track-seeking operation when the microprocessor is detected to be unoccupied, and controlling the coil actuator and the sled actuator to perform a true-seek procedure of the track-seeking operation according to results of the pre-seek procedure to move the pick-up head to a destination address of an optical disk;
wherein the pre-seek procedure performs preparatory tasks for the true-seek procedure.

16. The optical disk drive as claimed in claim 15, wherein the pre-seek procedure comprises determining a moving direction of the pick-up head, determining a jumped track number according to the initial address and the destination address, determining a velocity profile, determining a first driving force of a sled actuator of the optical disk drive, determining a second driving force of a coil actuator of the optical disk drive, and storing the results of the pre-seek procedure comprising the moving direction, the jumped track number, the velocity profile, the first driving force, and the second driving force in registers.

17. The optical disk drive as claimed in claim 15, wherein when the true-seek procedure is performed, the sled actuator moves the pick-up head according to the results of the pre-seek procedure; and the coil actuator moves the pick-up head to the destination address according to the results of the pre-seek procedure.

18. The optical disk drive as claimed in claim 15, wherein the prior operations are about processing a read command, one of the prior operations is a buffering operation buffering for buffering raw data read by a pickup head, one of the prior operations is a decoding operation for decoding the raw data to obtain a data segment, and one of the prior operations is a transferring operation for transferring the first data segment to a host.

19. The optical disk drive as claimed in claim 15, wherein the prior operations are about processing a write command, one of the prior operations is an encoding operation encoding a data segment to obtain encoded data, one of the prior operations is a recording operation recording the first encoded data on the optical disk, and one of the prior operations is a buffering operation buffering the second data segment sent by a host.

20. A method for processing commands in an optical disk drive, wherein processing of each command comprises a track-seeking operation and a plurality of other operations, and the track-seeking operation is divided into a pre-seek procedure and a true-seek procedure, the method comprising:
(a) performing the pre-seek procedure of a current command with a microprocessor of the optical disk drive;
(b) performing the other operations of the current command with the microprocessor;
(c) detecting whether the microprocessor is unoccupied while the other operations of the current command are performed;
(d) performing the pre-seek procedure of a next command with the microprocessor when the microprocessor is detected to be unoccupied before the other procedures of the current command are completed;
(e) after the other operations of the current command are completed, directly performing the true-seek procedure of the next command according to results of the pre-seek procedure of the next command to move the pick-up head to a destination address of an optical disk; and
(f) taking the next command as the current command to repeat steps (b) to (e) until all of the commands are processed.

21. The method as claimed in claim 20, wherein the pre-seek procedure comprising:
determining a moving direction of the pick-up head;
determining a jumped track number according to the initial address and the destination address;
determining a velocity profile;
determining a first driving force of a sled actuator of the optical disk drive;
determining a second driving force of a coil actuator of the optical disk drive; and
storing the results of the pre-seek procedure comprising the moving direction, the jumped track number, the velocity profile, the first driving force, and the second driving force in registers.

22. The method as claimed in claim 21, wherein the true-seek procedure comprises:
controlling the sled actuator to move the pick-up head according to the results of the pre-seek procedure; and
controlling the coil actuator to move the pick-up head to the destination address according to the results of the pre-seek procedure.

23. The method as claimed in claim 21, wherein the commands comprising the current command and the next command are Native Command Queuing (NCQ) read commands, the processing of each command comprises the track-seeking operation moving the pick-up head to a starting address of a data segment, a buffering operation buffering raw data read from the data segment, a decoding operation decoding the raw data to obtain the data segment, and a transferring operation transferring the data segment to a host, and the other operations comprise the buffering operation, the decoding operation, and the transferring operation.

24. The method as claimed in claim 21, wherein the commands comprising the current command and the next command are write commands, the processing of each command comprises a buffering operation buffering a data segment sent by a host, the track-seeking operation moving the pick-up head to a starting address of the data segment, an encoding operation encoding the data segment to obtain an encoded data, and a recording operation recording the encoded data on the optical disk, and the other operations comprise the encoding operation and the recording operation.
